(19) United States
(12) Patent Application Publication
(10) Pub. No.: US 2025/0304340 A1
(43) Pub. Date: Oct. 2, 2025

(54) Seal In a Lock

(71) Applicant: Albert Cornelius Dozier, Bastrop, TX (US)

(72) Inventor: Albert Cornelius Dozier, Bastrop, TX (US)

(21) Appl. No.: 18/624,157

(22) Filed: Apr. 2, 2024

(51) Int. Cl. B65D 55/14; E05B 37/02

(52) U.S. Cl. CPC B65D 55/145; E05B 37/02; B65D 2211/00; B65D 2255/00

(57) ABSTRACT

The present invention discloses a reusable lock and seal device for secure locking and sealing of containers. The device comprises an oval top with a scanning code, a rotary combination mechanism for code selection, reinforced sealing bars, and a latch for securing the lock to the container. The scanning code allows for easy identification and tracking, while the rotary combination ensures secure access control. The reinforced sealing bars create a tamper-resistant seal, and the latch securely fastens the lock to the container. The reusable nature of the device offers a cost-effective and eco-friendly solution compared to single-use seals. The invention addresses the limitations of traditional locking methods by providing enhanced security, tracking capabilities, and operational efficiency for various industries, including transportation, logistics, supply chain management, and e-commerce.

### FIELD OF THE DISCLOSURE

The present invention relates to the field of secure locking devices and systems. More specifically, it pertains to a reusable lock and seal device that incorporates a rotary combination mechanism, reinforced sealing bars, and a latch for securing containers or objects. The invention also encompasses the use of scanning codes for identification and tracking purposes, enhancing the overall security and efficiency of the locking system.

### BACKGROUND OF THE INVENTION

Securing containers and preventing unauthorized access to their contents has been a long-standing challenge across various industries. Traditional locking mechanisms, such as padlocks and single-use seals, have been widely used to address this issue. However, these conventional solutions often fall short in terms of reusability, tracking capabilities, and overall security.

Padlocks, while widely adopted, have several limitations. They are prone to picking, cutting, and other forms of tampering, compromising the security of the container. Additionally, padlocks often lack unique identification or tracking features, making it difficult to monitor and manage them effectively.

Single-use seals, on the other hand, provide tamper-evidence but are not reusable. Once a seal is broken, it cannot be used again, leading to increased costs and environmental waste. Furthermore, single-use seals often lack the strength and durability required for secure locking applications.

In an increasingly globalized and interconnected world, the need for advanced locking solutions has become more pressing. Industries such as transportation, logistics, and supply chain management require secure, reusable, and trackable locking devices to ensure the integrity of their goods and prevent theft or tampering during transit.

Moreover, with the rise of e-commerce and the growing demand for secure package delivery, there is a need for locking systems that can be easily integrated with tracking technologies. This integration enables real-time monitoring, reduces the risk of lost or stolen packages, and enhances overall operational efficiency.

Despite the advancements in locking technologies, there remains a gap in the market for a comprehensive solution that addresses the limitations of traditional locking methods while incorporating modern features such as reusability, tracking capabilities, and enhanced security.

The object of the present invention is to provide a reusable lock and seal device that overcomes the drawbacks of existing solutions. The invention aims to offer a secure, tamper-evident, and trackable locking system that can be easily integrated into various applications, improving the overall security and efficiency of container locking and sealing processes.

### SUMMARY

The present invention is a reusable lock and seal device designed to provide a secure, tamper-evident, and trackable solution for locking containers and preventing unauthorized access. The device features a unique combination of components, including an oval top with a scanning code, a rotary combination mechanism for code selection, reinforced sealing bars, and a latch for securing the lock to the container.

The oval top of the device incorporates a scanning code, such as a barcode or QR code, which allows for easy identification and tracking of the lock using electronic scanning devices. This feature enhances the overall efficiency of inventory management and monitoring.

The rotary combination mechanism enables users to input a specific code by rotating the combination to the appropriate positions, ensuring that only authorized individuals can unlock the device. This secure code selection method provides an additional layer of access control.

The lock and seal device includes reinforced sealing bars, consisting of a top seal part and a bottom seal part. These bars are designed to create a robust and tamper-resistant seal when the lock is in a closed state, preventing unauthorized access to the container.

A latch is incorporated into the device to securely fasten the lock to the container. The latch is connected to the bottom seal part and ensures that the container remains tightly sealed until the proper combination code is entered.

The reusable nature of the lock and seal device sets it apart from single-use seals, offering a more cost-effective and environmentally friendly solution. The device is constructed using durable materials, such as heavy-duty metal or tamper-evident plastics, to withstand repeated use and provide long-term reliability.

By combining the scanning code technology, rotary combination mechanism, reinforced sealing bars, and secure latch, the present invention offers a comprehensive and innovative solution for container locking and sealing. This reusable lock and seal device addresses the limitations of traditional locking methods and provides enhanced security, tracking capabilities, and operational efficiency for various industries, including transportation, logistics, supply chain management, and e-commerce.

### BRIEF DESCRIPTION OF THE DRAWING

FIG. 1 is a perspective view of the reusable lock and seal device.

FIG. 2 is a detailed illustration of the lock and seal device components.

FIG. 3 is an in-depth view of the lock and seal device features.

FIG. 4 is a latch mechanism that secures the lock to the container.

### DETAILED DESCRIPTION OF THE INVENTION

The terms “comprising,” “including,” “containing,” “characterized by,” and their grammatical equivalents, as used herein, are intended to be inclusive or open-ended, indicating the presence of stated features, integers, steps, operations, elements, and/or components, but not precluding the presence or addition of one or more other features, integers, steps, operations, elements, components, and/or groups thereof. Unless otherwise specified, all numbers expressing quantities, measurements, dimensions, and so forth used in the specification and claims are to be understood as being modified in all instances by the term “about,” indicating a close approximation to the stated value within a reasonable range.

The present invention introduces a novel reusable lock and seal device designed to enhance security, convenience, and tracking capabilities in various locking and sealing applications. The inventive device incorporates specific structural components and features arranged in a unique configuration, aimed at addressing the shortcomings of traditional locking mechanisms and single-use seals. The following detailed description presents various embodiments, aspects, and features of the present invention, which are intended to exemplify the preferred embodiments without limiting the scope of the invention.

One aspect of the present invention relates to a system for providing secure, tracked, and controlled access to shipments using reusable locks and a mobile app. The system comprises several interconnected components, including reusable lock devices, a mobile app for iOS and Android devices, a cloud-based server backend, and GPS tracking devices.

The reusable locks are the physical security components of the system. Each lock consists of two parts: a top portion and a bottom portion. When locked together, these two parts form a tamper-evident seal that prevents unauthorized access to the container or trailer latch. The locks are constructed from durable, weather-resistant materials such as hardened steel or reinforced polymers, designed to withstand the rigors of transport and frequent use. Each lock contains an embedded electronic module that controls the locking mechanism, which includes a keypad for code entry, a battery, a wireless communication chip (e.g., Bluetooth or Wi-Fi), and a microcontroller. The microcontroller runs firmware that manages the locking and unlocking process. When the correct access code is entered on the keypad, the microcontroller activates a servo or solenoid to release the locking mechanism, allowing the two halves of the lock to be separated. The battery provides power for the electronic components and is rechargeable, enabling wireless charging when the lock is not in use, ensuring a long service life. On the exterior of each lock, a unique identification number is clearly printed, which is used to associate the physical lock with its digital twin in the cloud-based tracking system. The ID is printed in both machine-readable (e.g., QR code) and human-readable formats.

The mobile app serves as the primary user interface for the system and is available for both iOS and Android devices. Users are required to authenticate with their username and password upon launching the app, which communicates with the cloud backend to verify the user's credentials and permissions. Once logged in, the app's main screen displays a list of active shipments associated with the user's account. Tapping on a shipment opens a detail view that shows the current location of the shipment on a map, the expected delivery date and time, and the ID of the lock attached to the shipment. The app periodically polls the cloud backend for updates to the shipment status and location, providing real-time information as the shipment progresses along its route. When a shipment arrives at its destination, the app sends a push notification to the user's device, prompting them to scan the ID of the lock attached to the shipment using the device's camera. The scanned ID is securely transmitted to the cloud backend for verification. If the backend confirms the lock ID is valid and the shipment has arrived at its intended destination, it generates a one-time access code unique to the specific lock with a limited validity period. The access code is securely transmitted back to the app and displayed to the user, who can then manually enter the code on the lock's keypad to unlock it. The app sends a confirmation to the backend upon successful unlocking, updating the shipment status to “delivered.” If the wrong code is entered or the lock is not opened within the validity period, the backend is notified and can generate alerts for further investigation.

The cloud backend is the central hub that coordinates all aspects of the system. It consists of several components, including a shipment database, user database, lock database, GPS tracking integration, access code generation, security and encryption, and alerts and notifications. The shipment database stores information about each shipment, such as its origin, destination, expected delivery date, and the ID of the associated lock, and is updated in real-time as shipments are created, updated, and delivered. The user database contains user accounts and permissions, used to authenticate users when they log in to the mobile app and ensure they only have access to authorized shipments and locks. The lock database maintains a record of each lock in the system, including its ID, current status (e.g., in use, available, in maintenance), and the access code currently assigned to it. The backend integrates with the GPS tracking devices attached to each shipment, periodically receiving location updates and using this information to update the shipment database and provide real-time tracking information to the mobile app. When a shipment arrives at its destination and the lock ID is scanned, the backend is responsible for generating the one-time access code, verifying the lock ID, confirming the shipment is at its intended destination, and ensuring the user requesting the code has the necessary permissions. The code generation algorithm ensures that codes are unique, random, and time-limited. All communication between the mobile app, the backend, and the lock devices is secured using industry-standard encryption protocols (e.g., SSL/TLS), with access codes and other sensitive information always transmitted in encrypted form to prevent interception. The backend monitors the system for any anomalies or suspicious activities, generating alerts for further investigation and sending notifications to users and administrators in case of important events.

To set up the system, each lock device must first be registered in the lock database by scanning the ID of the lock and associating it with a shipment in the shipment database. The GPS tracking devices are attached to the shipments and registered in the backend, configured to periodically send location updates over a cellular or satellite network. Users are created in the user database and assigned appropriate permissions based on their roles (e.g., driver, recipient, administrator), and the mobile app is installed on the users' devices and linked to their user accounts. When a new shipment is created, it is added to the shipment database along with its origin, destination, expected delivery date, and the associated lock ID. As the shipment progresses, the GPS tracking device sends location updates to the backend, which updates the shipment database and makes the information available to the mobile app. When the shipment arrives and the lock ID is scanned, the backend generates the access code and sends it to the mobile app. The user enters the code on the lock, which verifies it and unlocks if the code is correct. Throughout this process, the backend monitors for any issues or anomalies and generates alerts and notifications as needed.

By integrating these components-the reusable locks, mobile app, cloud backend, and GPS tracking-the system provides a secure, efficient, and auditable way to manage and control access to shipments throughout their journey.

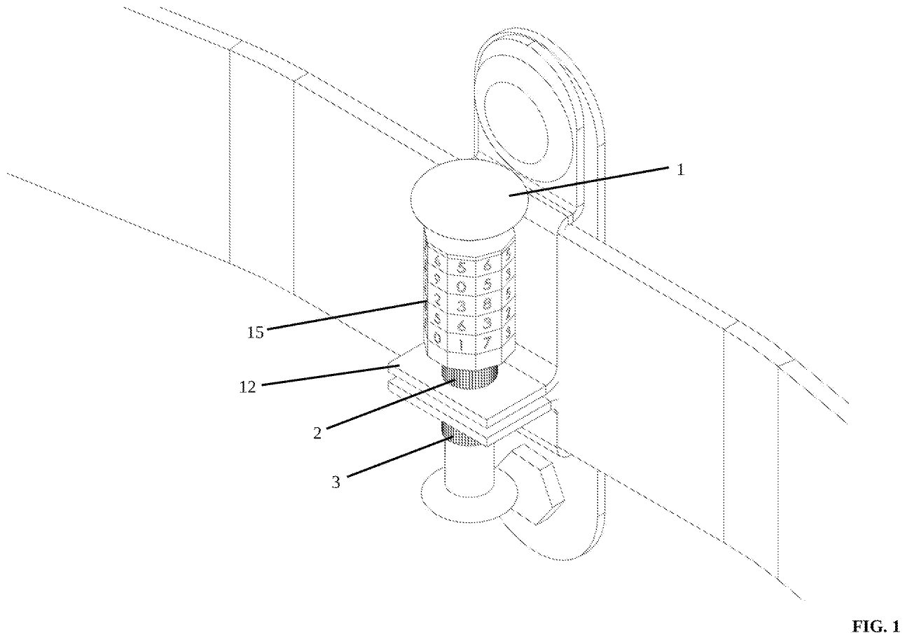

FIG. 1 illustrates a perspective view of the lock and seal device. The lock and seal device comprises an oval top (1) that serves as the upper portion of the lock. The oval top (1) is connected to a reinforced bar (2), which forms the top seal part of the lock. This reinforced bar (2) is designed to provide structural integrity and security to the locking mechanism.

At the lower portion of the lock, a second reinforced bar (3) is present, which forms the bottom seal of the lock. This reinforced bar (3) is positioned in a manner that allows it to interact with the top seal part (2) of the lock when the device is in a closed or locked state.

Situated between the top and bottom seal parts of the lock is a latch (12). The latch (12) is a mechanical component that facilitates the locking and unlocking of the device. When the lock is in a closed state, the latch (12) securely fastens the top and bottom seal parts together, preventing unauthorized access.

Integrated into the lock and seal device is a rotary combination mechanism (15). This rotary combination (15) is designed for code selection and serves as an integral part of the locking system. Users can input a specific code by rotating the combination to the appropriate positions, allowing for the secure locking and unlocking of the device.

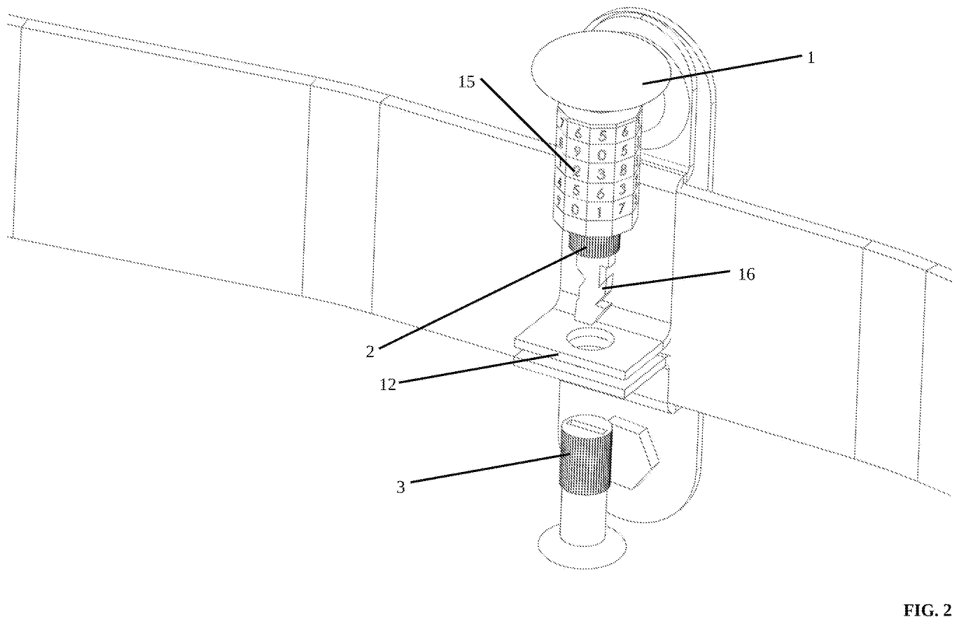

The FIG. 2 provides a detailed illustration of the lock and seal device, highlighting its key components and their functional relationships. At the top of the device, an oval top (1) is present, which serves as the upper portion of the lock. This oval top (1) may comprise a scanning code, which can be used for identification or tracking purposes. The scanning code can be a barcode, QR code, or any other suitable machine-readable format that allows for easy and accurate scanning by electronic devices.

Integrated into the lock and seal device is a rotary combination mechanism (15). This rotary combination (15) is designed for code selection and plays a crucial role in the locking and unlocking process. Users can input a specific code by rotating the combination to the appropriate positions, ensuring secure access control.

Connected to the rotary combination (15) is a lock release mechanism (16). This mechanism is responsible for controlling the opening and closing of the lock. When the proper combination is entered using the rotary combination (15), the lock release mechanism (16) is triggered, allowing the lock to be opened. This ensures that only authorized individuals with the correct code can gain access to the secured contents.

The lock and seal device features two reinforced bars-a top seal part (2) and a bottom seal part (3). These reinforced bars are integral components of the locking mechanism. The top seal part (2) is connected to the oval top (1) and extends downwards, while the bottom seal part (3) is positioned at the lower portion of the device. When the lock is in a closed state, the top seal part (2) and bottom seal part (3) are securely engaged, forming a robust and tamper-resistant seal.

To ensure the lock and seal device is securely attached to the container or object being protected, a latch (12) is present. This latch (12) is connected to the container and is designed to prevent unauthorized access. When the lock is in a closed state, the latch (12) is securely fastened, preventing the container from being opened. The latch (12) can only be released when the proper combination is entered using the rotary combination (15), triggering the lock release mechanism (16).

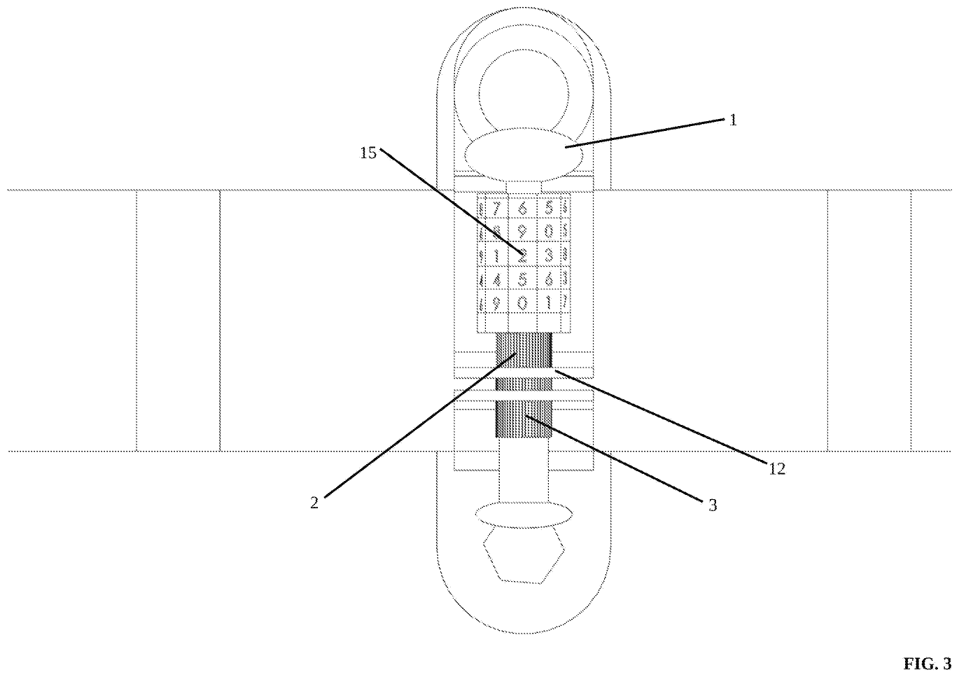

The FIG. 3 presents a detailed view of the lock and seal device, focusing on its main components and their arrangement. At the top of the device, an oval top (1) is prominently featured. This oval top (1) serves as the upper portion of the lock and may incorporate a scanning code. The scanning code, which can be in the form of a barcode, QR code, or any other suitable machine-readable format, allows for easy identification and tracking of the lock and seal device. The inclusion of the scanning code enables quick and accurate scanning by electronic devices, facilitating efficient inventory management and monitoring.

Positioned beneath the oval top (1) is the rotary combination (15). This rotary combination (15) is an essential component of the lock and seal device, as it is responsible for code selection and access control. Users can input a specific code by rotating the combination to the appropriate positions, ensuring that only authorized individuals can unlock the device. The rotary combination (15) provides a secure and reliable method for controlling access to the protected contents.

Connected to the container or object being secured is the latch (12). This latch (12) plays a vital role in preventing unauthorized access. When the lock and seal device is in a closed state, the latch (12) is securely fastened, effectively securing the container and preventing it from being opened. The latch (12) is designed to be robust and tamper-resistant, providing a high level of security.

The lock and seal device features two reinforced bars-a bottom seal part (3) and a top seal part (2). The bottom seal part (3) is located at the lower portion of the device and is connected to the latch (12). It serves as a structural component, providing strength and stability to the locking mechanism. The top seal part (2) is positioned above the bottom seal part (3) and is connected to the oval top (1). When the lock is in a closed state, the top seal part (2) and bottom seal part (3) are securely engaged, creating a tight and tamper-evident seal.

The arrangement of the components in FIG. 3 showcases the thoughtful design of the lock and seal device. The oval top (1) with scanning code allows for easy identification and tracking, while the rotary combination (15) provides secure code selection for access control. The latch (12) ensures the container is securely fastened, and the reinforced bars (2 and 3) contribute to the overall strength and integrity of the locking mechanism.

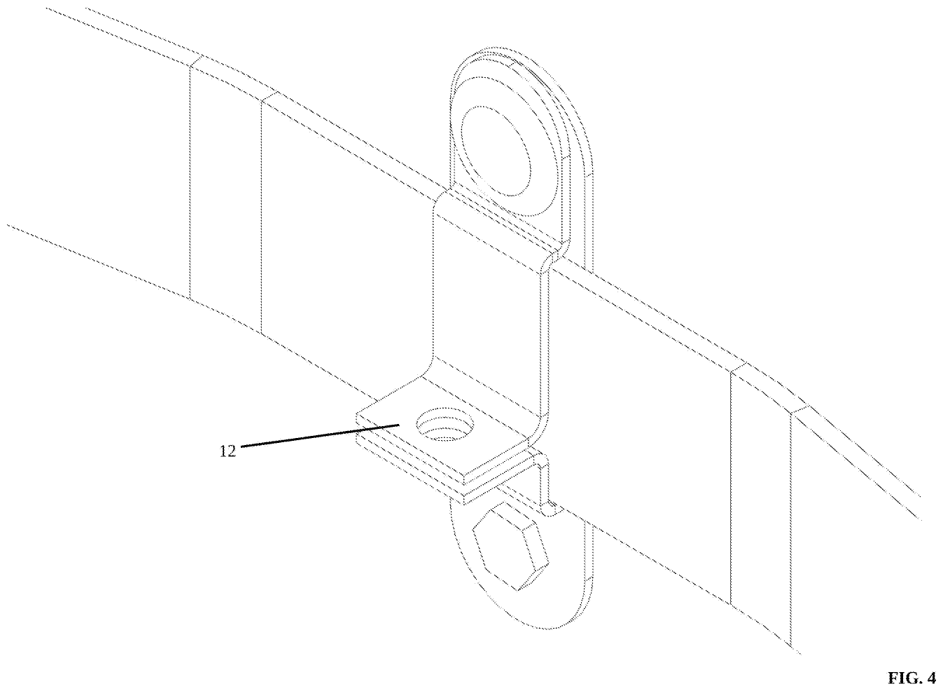

Further, FIG. 4 depicts a latch (12) that secures the lock to the container. Possible latch mechanisms include cam locks, hook bolts, or spring-loaded pins. Construction styles may vary, such as heavy-duty metal for durability or tamper-evident materials to detect unauthorized access attempts. The latch ensures a strong, secure connection.

### Industrial Application

The reusable lock and seal device finds extensive applications in industries such as transportation, logistics, supply chain management, and e-commerce. It provides a secure and efficient solution for locking and sealing containers, ensuring the integrity of goods during transit and storage. The device's unique combination of scanning code technology, rotary combination mechanism, reinforced sealing bars, and secure latch offers enhanced security, tamper-evidence, and tracking capabilities. This makes it ideal for securing high-value or sensitive cargo, preventing theft, and facilitating real-time monitoring. The invention's reusable nature also reduces costs and environmental waste associated with single-use seals, making it a sustainable choice for industries seeking improved locking solutions.

What is claimed is:

1. A reusable lock and seal device comprising:
a. an oval top comprising a scanning code;
b. a rotary combination mechanism for code selection;
c. reinforced sealing bars, including a top seal part and a bottom seal part;
d. a latch for securing the lock to a container; and
e. a lock release mechanism, wherein the lock release mechanism is triggered when a correct combination code is entered using the rotary combination mechanism.

2. The reusable lock and seal device of claim 1, wherein the scanning code is a barcode or a QR code.

3. The reusable lock and seal device of claim 1, wherein the rotary combination mechanism comprises a plurality of rotatable dials.

4. The reusable lock and seal device of claim 1, wherein the reinforced sealing bars are constructed from heavy-duty metal or tamper-evident materials.

5. The reusable lock and seal device of claim 1, wherein the latch is selected from the group consisting of a cam lock, a hook bolt, and a spring-loaded pin.

6. The reusable lock and seal device of claim 1, wherein the lock release mechanism comprises a servo or a solenoid.

7. The reusable lock and seal device of claim 1, wherein the device is constructed from durable materials suitable for repeated use.

8. The reusable lock and seal device of claim 1, wherein the device is configured to provide tamper-evidence when unauthorized access is attempted.

9. A secure locking system comprising:
a. a reusable lock and seal device according to claim 1;
b. a container having a latch interface for engaging with the latch of the reusable lock and seal device;
c. a scanning device for reading the scanning code on the oval top of the reusable lock and seal device; and
d. a tracking system for monitoring the location and status of the container sealed with the reusable lock and seal device.

10. The secure locking system of claim 9, wherein the scanning device is a handheld scanner or a smartphone with a scanning application.

11. The secure locking system of claim 9, wherein the tracking system utilizes GPS, RFID, or a combination thereof for monitoring the location of the container.

12. The secure locking system of claim 9, wherein the tracking system provides real-time alerts when unauthorized access to the container is detected.

13. The secure locking system of claim 9, wherein the tracking system maintains a log of access attempts and user interactions with the reusable lock and seal device.

14. A method for securing a container using a reusable lock and seal device, the method comprising:
a. providing a reusable lock and seal device according to claim 1;
b. setting a unique combination code using the rotary combination mechanism of the reusable lock and seal device;
c. engaging the latch of the reusable lock and seal device with a latch interface on the container;
d. scanning the scanning code on the oval top of the reusable lock and seal device to initiate tracking;
e. monitoring the location and status of the container using a tracking system; and
f. disengaging the latch of the reusable lock and seal device from the latch interface on the container by entering the unique combination code using the rotary combination mechanism.

15. The method of claim 14, further comprising the step of generating an alert when unauthorized access to the container is detected.

16. The method of claim 14, further comprising the step of updating the tracking system with the location and status of the container at predetermined intervals.

17. The method of claim 14, wherein the step of monitoring the location and status of the container is performed using GPS, RFID, or a combination thereof.

18. The method of claim 14, further comprising the step of maintaining a log of access attempts and user interactions with the reusable lock and seal device.

19. The method of claim 14, further comprising the step of replacing the reusable lock and seal device with a new device after a predetermined number of uses.

20. The method of claim 14, further comprising the step of inspecting the reusable lock and seal device for signs of tampering or damage before each use.
